(19) United States
(12) Patent Application Publication
(10) Pub. No.: US 2018/0348166 A1
(43) Pub. Date: Dec. 6, 2018

(54) SENSOR ELEMENT AND SENSOR DEVICE

(71) Applicant: KYOCERA CORPORATION, Kyoto (JP)

(72) Inventor: Kyohei KOBAYASHI, Kyoto (JP)

(21) Appl. No.: 15/771,883

(22) PCT Filed: Feb. 28, 2017
(86) PCT No.: PCT/JP2017/008015

§ 371 Date: Apr. 27, 2018

(30) Foreign Application Priority Data
Feb. 29, 2016 (JP) 2016-038436

(51) Int. Cl. G01N 29/02

(52) U.S. Cl. CPC G01N 29/022

(57) ABSTRACT

There are provided a sensor element and a sensor device having high measurement accuracy by improving temperature characteristics. A sensor element includes an element substrate, a detection portion located on an upper surface of the element substrate, and a protective film covering at least a first IDT electrode and a second IDT electrode. The element substrate is formed of quartz and has the following Euler angles, φ=0°, 97.2°≤θ≤128.9°, and 85°≤ψ≤95°. An expression 0<tc≤0.17λ is satisfied, in which tc denotes a thickness of a part of the protective film covering the first IDT electrode and the second IDT electrode, namely denotes a thickness standardized by a wavelength λ (μm) of a surface acoustic wave.

### TECHNICAL FIELD

The present invention relates to a sensor element and a sensor device.

### BACKGROUND ART

There is a heretofore known surface acoustic wave sensor element for measuring properties or constituents of an analyte liquid by detecting a detection target contained in the analyte liquid via an antibody bound to the surface of the element using an acoustic wave (refer to Patent Literature 1, for example). A sensor device which incorporates the sensor element is required to be constructed as a structurally simplified system of compact design capable of withstanding service under various environmental conditions.

### CITATION LIST

### Patent Literature

Patent Literature 1: WO 2013/108608

### SUMMARY OF INVENTION

A sensor element in accordance with one embodiment of the invention is a sensor for detecting a detection target contained in a sample. The sensor element comprises: a quartz substrate having the following Euler angles, φ=0°, 97.2°≤θ≤128.9°, and 85°≤ψ≤95°; a detection section located on an upper surface of the quartz substrate; and a protective film. The detection section includes a reaction portion which reacts with the detection target, a first IDT electrode which generates a surface acoustic wave which propagates toward the reaction portion, and a second IDT electrode which receives a surface acoustic wave which has passed through the reaction portion. The protective film covers at least the first IDT electrode and the second IDT electrode. An expression 0<tc≤0.17λ is satisfied, in which tc denotes a thickness of a part of the protective film covering the first IDT electrode and the second IDT electrode, namely denotes a thickness standardized by a wavelength λ (μm) of the surface acoustic wave.

A sensor device in accordance with one embodiment of the invention comprises: the above-described sensor element in which the reactant is bound, via an immobilization film, to the quartz substrate; a supply section which delivers the sample containing the detection target to the detection section of the sensor element; and a signal processing section which detects the detection target based on an electrical signal outputted from the sensor element.

### BRIEF DESCRIPTION OF DRAWINGS

The objects, features, and advantages of the invention will become more apparent by reference to the following detailed description in conjunction with the accompanying drawings.

FIG. 1 is a schematic view showing the electrical configuration of a sensor device according to a first embodiment;

FIGS. 2(a), 2(b), and 2(c) are a plan view, a lengthwise sectional view, and a widthwise sectional view, respectively, each showing a main body of the sensor device;

FIG. 3 is an exploded plan view of a sensor device main body;

FIG. 4 is a plan view showing procedural steps of the manufacturing of the sensor device main body;

FIG. 5 is a plan view showing a sensor element of the sensor device main body;

FIG. 6 is a sectional view showing part of the sensor device main body around the sensor element;

FIG. 7 is a sectional view showing the sensor element;

FIG. 8 is a plan view showing a sensor element according to a second embodiment;

FIG. 9 is a sectional view showing a sensor element according to a third embodiment; and

FIG. 10 is a schematic view showing procedural steps for the manufacturing of the sensor element.

### DESCRIPTION OF EMBODIMENTS

Practical realization of easy and speedy medical examination such as a blood test at an other-than-hospital location such as at home or at pharmacy is conducive to early detection of a disease and early medical treatment for the disease. Testing equipment for use in such a case is preferably designed as a system which is compact and simple in structure, and yet withstands service under various environmental conditions. However, for example, a sensor element of conventional design undergoes characteristic variation with changes in ambient temperature, which leads to difficulties in attaining high measurement accuracy.

In accordance with a sensor element according to the embodiment of the invention, by providing a quartz substrate having specific Euler angles; and a protective film having a specific thickness, it is possible to reduce phase variation in surface acoustic waves caused by changes in temperature.

Moreover, in accordance with a sensor device according to the embodiment of the invention, by providing the sensor element described above, highly accurate measurement can be performed with a compact and simple configuration.

The following describes the details of a sensor element and a sensor device according to the embodiment of the invention with reference to the drawings. In each of the drawings to be referred to in the following description, like constituent members are identified with the same reference symbols. Moreover, the size of each member and the distance between the individual members are schematically represented in each drawing and may therefore differ from the actual measurements.

### First Embodiment

A sensor device according to the embodiment of the invention comprises: a sensor element; a supply section which delivers a sample containing a detection target to the sensor element; and a signal processing section which detects the detection target based on an electrical signal outputted from the sensor element.

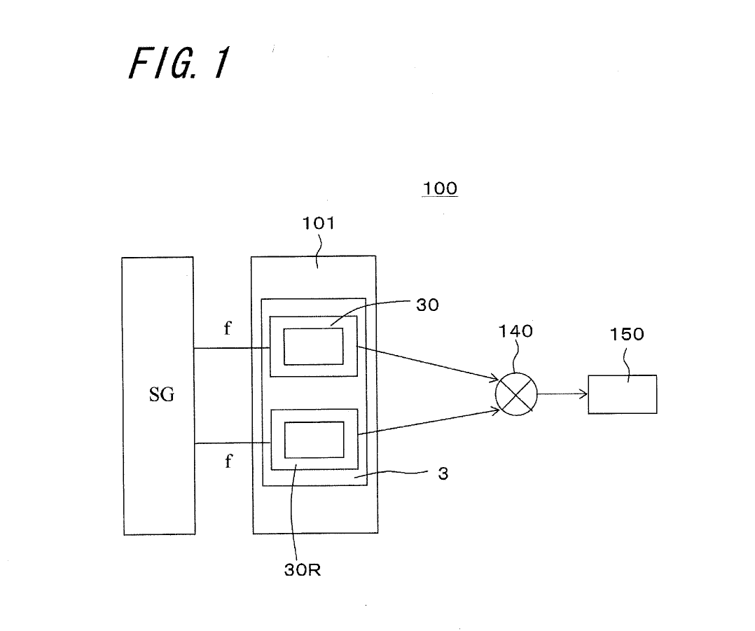

FIG. 1 is a schematic block diagram showing the electrical configuration of a sensor device 100 according to the present embodiment. The sensor device 100 comprises: a signal generator SG; a sensor device main body 101 including a sensor element 3; a calculation section 140; and a measurement section 150.

The signal generator SG generates a signal having a frequency of f, and outputs the generated signal to the sensor element 3. As will hereafter be described in detail, the sensor element 3 has a detection section 30 for detecting a detection target and a reference section 30R, and, the signal outputted from the signal generator SG is inputted to each of the detection section 30 and the reference section 30R.

With the supply of a sample containing a detection target received by the sensor element 3, upon input of the signal outputted from the signal generator SG to each of the detection section 30 and the reference section 30R, then a detection signal corresponding to the detection target is outputted from each of the detection section 30 and the reference section 30R.

Based on the detection signal outputted from the sensor element 3, the calculation section 140 determines a detection voltage by calculation using a predetermined calculating method such for example as a heterodyne method. Based on the detection voltage calculated by the calculation section 140, the measurement section 150 detects the presence or absence of the detection target contained in the sample or the content of the detection target contained in the sample.

In the present embodiment, the calculation section 140 and the measurement section 150 constitute the signal processing section. Note that the constituent components of the signal processing section are not limited to the calculation section 140 and the measurement section 150, and the signal processing section may thus be configured in any form that enables detection of a detection target based on an electrical signal outputted from the sensor element.

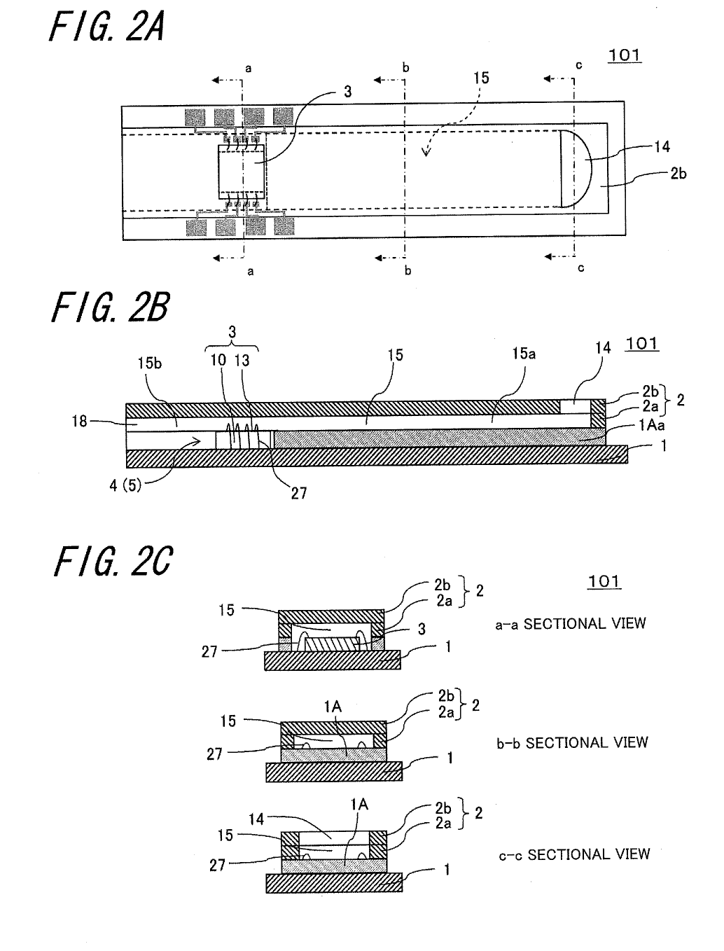

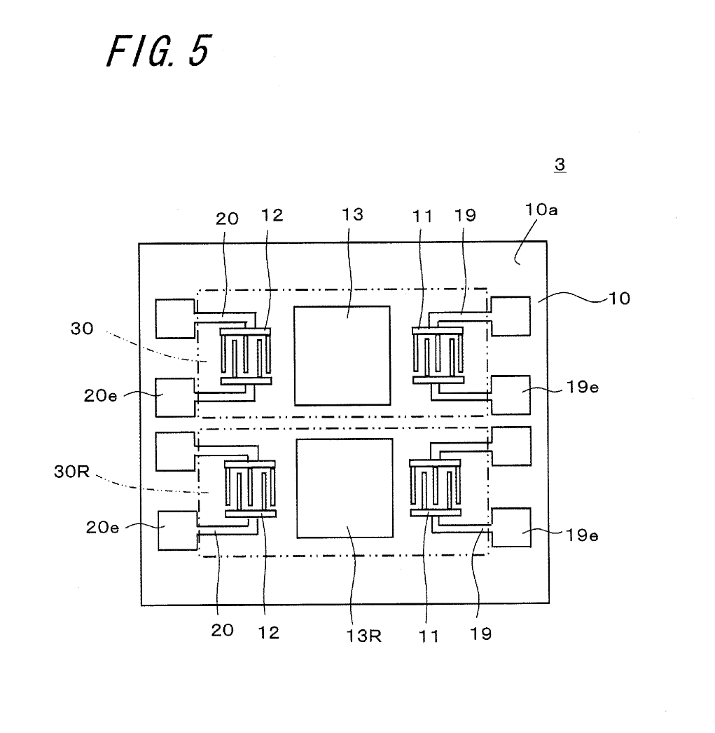

Next, the sensor device main body 101 will be described with reference to FIGS. 2 to 4, and the sensor element 3 according to the present embodiment will be described with reference to FIGS. 5 to 7. The sensor device main body 101 comprises the sensor element 3 and a supply section which delivers a sample containing a detection target to the sensor element 3.

As shown in FIG. 2, the sensor device main body 101 in the present embodiment mainly comprises a first cover member 1, an intermediate cover member 1A, a second cover member 2, and the sensor element 3.

More specifically, as shown in FIG. 2(b), the sensor device main body 101 has an inlet 14 into which an analyte liquid which is a sample flows, and a flow channel 15 which is continuous with the inlet 14, is surrounded by the intermediate cover member 1A and the second cover member 2, and extends at least to a reaction portion 13. In the present embodiment, the intermediate cover member 1A and the second cover member 2 are greater in width than the sensor element 3. This allows the analyte liquid to flow so as to effectively cover the entire area of the surface of the sensor element 3.

In FIG. 2(c), there are shown sections of the construction shown in FIG. 2(a) that are, in top-to-bottom order as seen in the drawing, the section taken along the line a-a, the section taken along the line b-b, and the section taken along the line c-c, respectively. The inlet 14 is formed so as to pass through the second cover member 2 in the direction of its thickness.

(First Cover Member)

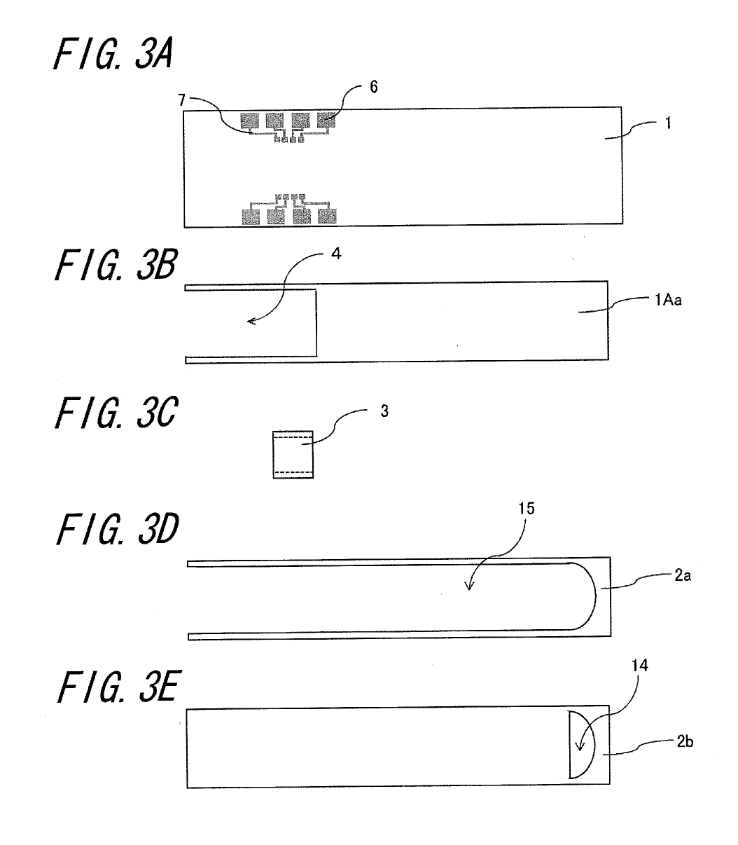

As shown in FIGS. 2(a), 2(b), and 3(a), the first cover member 1 is shaped in a flat plate. The first cover member 1 has a thickness of 0.1 mm to 1.5 mm, for example. The first cover member 1 is substantially rectangular in plan configuration. The first cover member 1 has a longitudinal length of 1 cm to 8 cm, for example, and has a widthwise length of 1 cm to 3 cm, for example.

As the material for forming the first cover member 1, it is possible to use, for example, a glass-epoxy material, paper, plastics, celluloid, ceramic, non-woven fabric, or glass. The use of plastics is desirable from the standpoint of required strength, as well as from a cost standpoint.

Moreover, as shown in FIG. 3(a), a terminal 6 and a wiring line 7 routed from the terminal 6 to a location near the sensor element 3 is formed on the upper surface of the first cover member 1.

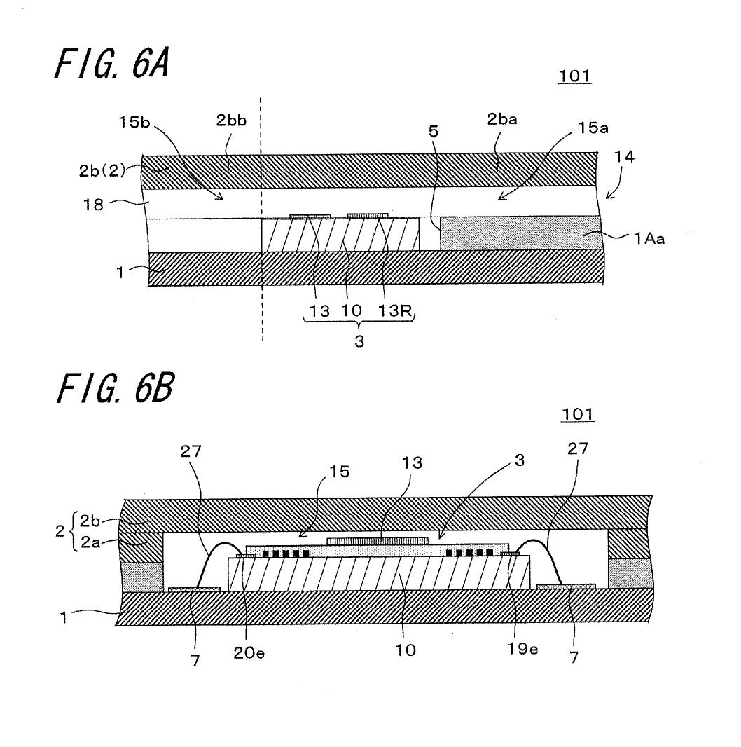

The terminal 6 is formed on the upper surface of the first cover member 1 so as to be located on each side of the sensor element 3 in the width direction. More specifically, at least part of the terminals 6 facing the sensor element 3 lies closer to the inlet 14 than the inlet 14-side end of the sensor element 3. Moreover, in an arrangement of four terminals 6 located on one side of the sensor element 3 with respect to a longitudinal direction of the flow channel 15, the wiring lines 7 each connected to corresponding one of the outer two terminals 6 are substantially equal in length, and also the wiring lines 7 each connected to corresponding one of the inner two terminals 6 are substantially equal in length. This makes it possible to reduce variation in signals obtained by the sensor element 3 due to the difference in length between the wiring lines 7. In this case, for example, when inputting an electrical signal from the signal generator SG to a first IDT electrode 11 as shown in FIG. 6 via the wiring line 7, a first extraction electrode, etc., so long as one pair of the wiring lines 7 having substantially the same length, which serves as ground (earth) wiring, and the other pair of the wiring lines 7 having substantially the same length, which serves as signal wiring, are connected together so that a potential difference can be produced between them, it is possible to reduce signal variation and thereby ensure higher detection reliability.

The sensor element 3 of the sensor device main body 101 can be connected to the calculation section 140 by providing electrical connection between the calculation section 140 and the terminal 6 located opposite to the terminal 6 connected to the signal generator SG, with the sensor element 3 lying between the opposed terminals 6. Moreover, the terminal 6 and the sensor element 3 are electrically connected to each other via the wiring line 7, etc.

In sample measurement operation, a signal from the signal generator SG is inputted, via the terminal 6, to the sensor element 3 of the sensor device main body 101, and, a signal from the sensor element 3 is outputted, via the terminal 6, to the calculation section 140.

(Intermediate Cover Member 1A)

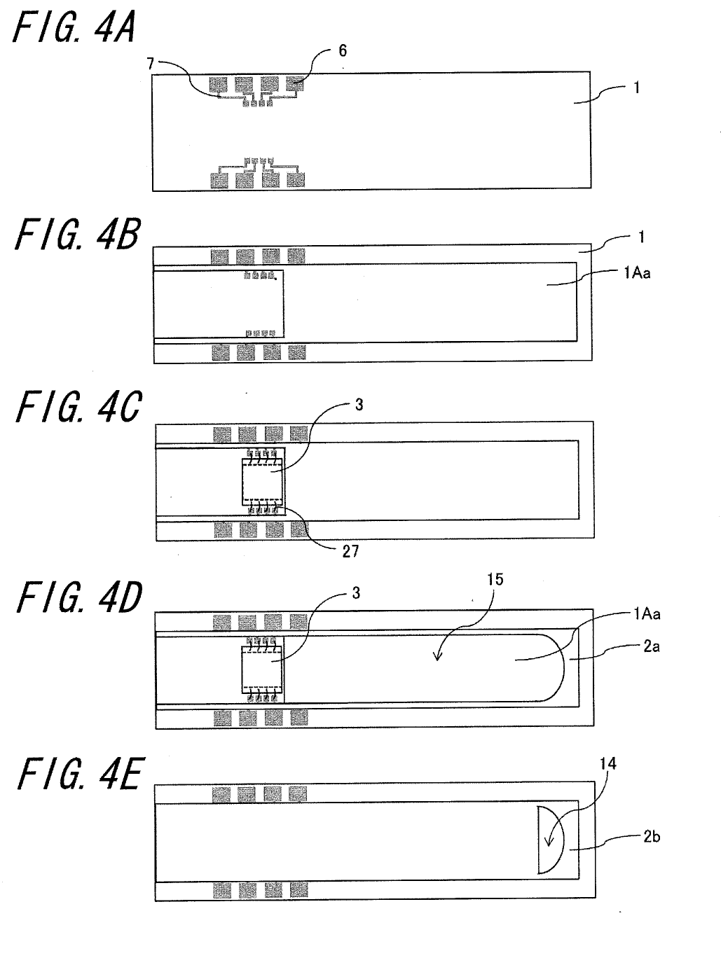

In the present embodiment, as shown in FIG. 2(b), the intermediate cover member 1A is placed in juxtaposition to the sensor element 3 on the upper surface of the first cover member 1. Moreover, as shown in FIGS. 2(a) and 4(c), the intermediate cover member 1A and the sensor element 3 are spaced apart. Alternatively, the intermediate cover member 1A and the sensor element 3 may be placed with their sides kept contact with each other.

As shown in FIGS. 2(b) and 3(b), the intermediate cover member 1A has the form of a frame-like flat plate having a recess-forming area 4, and, a thickness thereof falls in the range of 0.1 mm to 0.5 mm, for example.

In the present embodiment, as shown in FIG. 2(b), the recess-forming area 4 is located downstream of a first upstream portion 1Aa of the intermediate cover member 1A. Upon joining the intermediate cover member 1A to the flat plate-shaped first cover member 1, an element receiving portion 5 is defined by the first cover member 1 and the intermediate cover member 1A. That is, the upper surface of the first cover member 1 located inside the recess-forming area 4 becomes the bottom surface of the element receiving portion 5, and the inner wall of the recess-forming area 4 becomes the inner wall of the element receiving portion 5.

As shown in FIGS. 2 and 4, in a region downstream from the sensor element 3, the intermediate cover member 1A does not exist on the first cover 1. This makes it possible to suppress or reduce occurrence of air bubbles in a region downstream from the first upstream portion 1Aa constituting the intermediate cover member 1A, and thereby deliver the analyte liquid in the form of bubble-free liquid onto the sensor element 3, with consequent improvement in detection sensitivity or detection accuracy.

As the material for forming the intermediate cover member 1A, it is possible to use, for example, resin (including plastics), paper, non-woven fabric, and glass. More specifically, resin materials such as polyester resin, polyethylene resin, acrylic resin, and silicone resin can be used. The first cover member 1 and the intermediate cover member 1A may be formed either of the same material or of different materials.

Moreover, in the present embodiment, the intermediate cover member 1A comprises the first upstream portion 1Aa, and, as shown in FIGS. 2(a) and 2(b), the sensor element 3 is located downstream of the first upstream portion 1Aa, as seen in top view. With this arrangement, when the analyte liquid flows over the sensor element 3 after passing through that part of the flow channel 15 which corresponds to the first upstream portion 1Aa, an excess of the analyte liquid over that required for measurement flows downstream, whereby an adequate amount of the analyte liquid can be delivered to the sensor element 3.

(Second Cover Member 2)

As shown in FIGS. 2(b) and 4(e), the second cover member 2 is joined to the first cover member 1 and the intermediate cover member 1A while covering the sensor element 3. As shown in FIGS. 2(b) and 2(c), the second cover member 2 comprises a third substrate 2a and a fourth substrate 2b.

As the material for forming the second cover member 2, it is possible to use, for example, resin (including plastics), paper, non-woven fabric, and glass. More specifically, resin materials such as polyester resin, polyethylene resin, acrylic resin, and silicone resin can be used. It is advisable that the second cover member 2 and the first cover member 1 are formed of the same material. This makes it possible to reduce deformation resulting from the difference in thermal expansion coefficient between these cover members. The second cover member 2 may either be joined only to the intermediate cover member 1A or be joined to both of the first cover member 1 and the intermediate cover member 1A.

As shown in FIGS. 2(c), 4(c) and 4(d), the third substrate 2a is bonded to the upper surface of the intermediate cover member 1A. The third substrate 2a is shaped in a flat plate having a thickness of 0.1 mm to 0.5 mm, for example. The fourth substrate 2b is bonded to the upper surface of the third substrate 2a. The fourth substrate 2b is shaped in a flat plate having a thickness of 0.1 mm to 0.5 mm, for example. Upon joining the fourth substrate 2b to the third substrate 2a, as shown in FIG. 2(b), the flow channel 15 is formed below the fourth substrate 2b. The flow channel 15 extends from the inlet 14 to at least a region immediately above the reaction portion 13 on the sensor element 3, and, for example, the flow channel 15 has a rectangular sectional profile. The third substrate 2a and the fourth substrate 2b may be formed of the same material, and may also be designed in one-piece structure.

In the present embodiment, as shown in FIG. 2(b), at the downstream-side end of the flow channel 15, the intermediate cover member 1A and the third substrate 2a do not exist, and, a gap between the fourth substrate 2b and the first cover member 1 serves as an exhaust hole 18. The exhaust hole 18 serves to discharge air or the like in the flow channel 15 to the outside. An opening shape of the exhaust hole 18 may have any shape, such as a circular shape or a rectangular shape, as long as air can be removed from the flow channel 15. For example, the exhaust hole 18 having a circular opening is set at or below 2 mm in diameter, whereas, the exhaust hole 18 having a rectangular opening is set at or below 2 mm in side length.

The first cover member 1, the intermediate cover member 1A, and the second cover member 2 may be formed of the same material. This makes it possible to render the individual members substantially uniform in thermal expansion coefficient, and thereby protect the sensor device main body 101 from deformation resulting from the difference in thermal expansion coefficient among these members. Moreover, there may be a case where a biological material is applied to the reaction portion 13. In this regard, among biological materials, some are susceptible to quality degradation under exposure to external light such as ultraviolet radiation. It is thus advisable to use an opaque material having light-blocking capability for the first cover member 1, the intermediate cover member 1A, and the second cover member 2. On the other hand, for a case where external light-caused quality degradation hardly occurs in the reaction portion 13, the second cover member 2 defining the flow channel 15 may be formed of a nearly transparent material. This permits visual observation of the condition of the analyte liquid flowing through the interior of the flow channel 15, wherefore an optical detection method can be used in combination.

(Sensor Element 3)

The sensor element 3 according to the present embodiment will be described with reference to FIGS. 5 to 7.

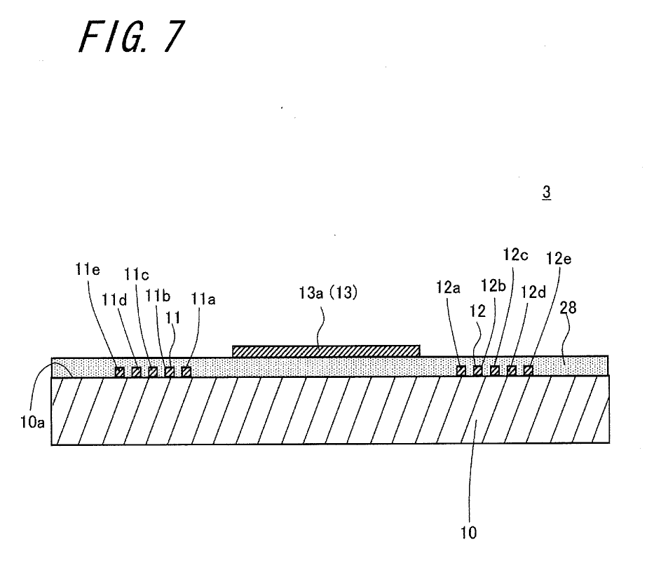

FIG. 5 is a plan view showing the sensor element 3. FIG. 6 is a sectional view showing part of the sensor device main body 101 around the sensor element 3, and FIG. 7 is a sectional view showing the sensor element 3.

The sensor element 3 is mainly composed of an element substrate 10 located on the upper surface of the first cover member 1; and at least one detection section 30 which is located on an upper surface 10a of the element substrate 10 which is located opposite to the first cover member 1, and detects a detection target contained in an analyte liquid. Note that “a component located on the upper surface 10a” is not limited to one placed so as to directly contact with the upper surface 10a, but is construed as subsuming a component placed indirectly on the upper surface 10a, with other member lying in between. Similar conditions hold true throughout the following description.

More specifically, the sensor element 3 in the present embodiment comprises: the element substrate 10; the detection section 30 located on the upper surface 10a of the element substrate 10, the detection section 30 including a reaction portion 13 which reacts with a detection target, a first IDT (Inter Digital Transducer) electrode 11 which generates a surface acoustic wave which propagates toward the reaction portion 13, and a second IDT electrode 12 which receives a surface acoustic wave which has passed through the reaction portion 13; and a protective film 28 which covers at least the first IDT electrode 11 and the second IDT electrode 12. The sensor element 3 may be further provided with a reference section 30R. The reference section 30R may be composed of a metallic film 13R, a first IDT electrode 11 which generates a surface acoustic wave which propagates toward the metallic film 13R, and a second IDT electrode 12 which receives a surface acoustic wave which has passed through the metallic film 13R. In this case, the protective film 28 also covers at least the first IDT electrode 11 and the second IDT electrode 12 of the reference section 30R. Note that the metallic film 13R does not necessarily have to be provided in the reference section 30R.

On the upper surface 10a of the element substrate 10, in addition to the first IDT electrode 11, the reaction portion 13, the metallic film 13R, and the second IDT electrode 12, a first extraction electrode 19 and a second extraction electrode 20 are provided.

(Element Substrate 10)

The element substrate 10 is a quartz substrate having the following Euler angles, φ=0°, 97.2°≤θ≤128.9σ, and 85°≤ψ≤95°, or more specifically having the following Euler angles, φ=0°, 110.0°≤θ≤128.9°, and 85°≤ψ≤95°. The plan configuration and dimensions of the element substrate 10 are suitably determined. For example, the element substrate 10 has a thickness tb which satisfies 0.3 mm≤tb≤1 mm, or more specifically satisfies 0.35 mm≤tb≤0.55 mm.

In the present embodiment, the surface roughness of that part of the element substrate 10 provided with an immobilization film 13a is smaller than the surface roughness of the upper surface of the immobilization film 13a. Thus, for example, with respect to the case where an aptamer or an antibody as will hereafter be described is immobilized on the surface of the element substrate 10, the bindability and adherability of the aptamer or antibody to the surface of the immobilization film 13a can be enhanced, thus enabling immobilization with higher density. This makes it possible to increase the detection sensitivity of the detection target.

(IDT Electrodes 11 and 12)

As shown in FIGS. 5 and 7, the first IDT electrode 11 comprises a pair of comb-like electrodes including two bus bars opposed to each other and a plurality of electrode fingers 11a to 11e (11a, 11b, 11c, 11d and 11e) each extending from corresponding one of the bus bars toward the other. The pair of comb-like electrodes is disposed so that the plurality of electrode fingers 11a to 11e are arranged in an interdigitated manner. The second IDT electrode 12 is similar in configuration to the first IDT electrode 11. The first IDT electrode 11 and the second IDT electrode 12 constitute a transversal IDT electrode.

The first IDT electrode 11 generates a surface acoustic wave (SAW) in response to an input signal from the signal generator SG, and the second IDT electrode 12 receives the SAW generated in the first IDT electrode 11, and outputs a signal based on the received SAW to the calculation section 140. The first IDT electrode 11 and the second IDT electrode 12 are arranged in line with each other so that the SAW generated in the first IDT electrode 11 can be received by the second IDT electrode 12. The design of frequency response characteristics of SAW can be made on the basis of the number of the electrode fingers of the first IDT electrode 11 and the second IDT electrode 12, the distance between the adjacent electrode fingers, the intersection width of the electrode fingers, etc., used as parameters.

Among various existing modes of vibration for SAW to be excited by the IDT electrode, for example, a vibration mode of transversal waves called SH waves is utilized in the sensor element 3 according to the present embodiment. For example, the frequency of SAW may be adjusted to fall within a range of several megahertz (MHz) to several gigahertz (GHz). By setting the SAW frequency within a range of several hundred MHz to 2 GHz in particular, it is possible to provide suitability for practical use, as well as to achieve a reduction in size of the sensor element 3 and hence miniaturization of the sensor device main body 101 as a whole. The thicknesses and lengths of predetermined constituent elements in the present embodiment will be described with respect to the case where the center frequency of SAW is set to a several hundred MHz.

The first IDT electrode 11 and the second IDT electrode 12 may be either of a single-layer structure composed of, for example, a gold thin layer, or of a multilayer structure such as a three-layer structure obtained by successively laminating a titanium layer, a gold layer, and a titanium layer in the order named, or a chromium layer, a gold layer, and a chromium layer in the order named, from the element substrate 10 side.

A thickness of each of the first IDT electrode 11 and the second IDT electrode 12 is set in a range of 0.005λ to 0.015λ, for example. Note that a thickness expressed in λ refers to a thickness standardized by the wavelength λ (μm) of a surface acoustic wave. In the following description, each and every thickness expressed in λ refers to a standardized thickness.

For the purpose of reducing SAW reflection, an elastic member may be disposed externally of the first IDT electrode 11 and the second IDT electrode 12 in the direction of SAW propagation (width direction).

(Protective Film 28)

In the present embodiment, the protective film 28 is located on the upper surface 10a of the element substrate 10 so as to cover at least the first IDT electrode 11 and the second IDT electrode 12, or equivalently part of the upper surface 10a of the element substrate 10. In the present embodiment, as shown in FIG. 7, the protective film 28 may continuously cover a region from the first IDT electrode 11 to the second IDT electrode 12. In this case, the protective film 28 may also cover a part of the surface of the element substrate 10 which part lies between the first IDT electrode 11 and the second IDT electrode 12.

The thickness of the protective film 28, or equivalently a thickness tc of a part of the protective film 28 covering the first IDT electrode 11 and the second IDT electrode 12 satisfies 0<tc≤0.17λ, or more specifically satisfies 0<tc≤0.05λ. In the present embodiment, a part of the protective film 28 covering the first IDT electrode 11 and the second IDT electrode 12 and a part of the protective film 28 covering the region between the first IDT electrode 11 and the second IDT electrode 12 have the same thickness. In measuring the thickness of the protective film 28, a part thereof which does not cover the first IDT electrode 11 and the second IDT electrode 12 may be subjected to the measurement, and yet, the execution of measurement on other location than the above-described part shall not be ruled out.

As shown in FIG. 7, the protective film 28 may be made greater in thickness than the first IDT electrode 11 and the second IDT electrode 12. This makes it possible to suppress contact of an analyte liquid with the first IDT electrode 11 and the second IDT electrode 12, and reduce corrosion due to oxidation of the IDT electrodes or the like. Examples of the material for forming the protective film 28 include silicon oxide, aluminum oxide, zinc oxide, titanium oxide, silicon nitride, and silicon. Each such material is used as a major constituent of the protective film 28, expressed differently, a component constituting the greatest proportion in mass in the protective film-forming material, and is therefore not defined as the constituent material when mixed as impurities in very small amounts.

As shown in FIG. 7, the first IDT electrode 11 and the second IDT electrode 12 include a plurality of electrode fingers 11a to 11e which are located apart from each other and a plurality of electrode fingers 12a to 12e (12a, 12b, 12c, 12d, and 12e) which are located apart from each other, respectively. The protective film 28 is continuously extends over the surface (top surface and side surface) of each of two adjacent electrode fingers, for example, the electrode fingers 11a and 11b (12a and 12b), of the plurality of electrode fingers 11a to 11e (12a to 12e), and also extends over a part of the upper surface 10a of the element substrate 10 which part lies between these two electrode fingers 11a and 11b (12a and 12b). In this case, since the plurality of electrode fingers of the IDT electrode are covered with the protective film 28 without being exposed, it is possible to suppress occurrence of electrical short-circuiting among the mutual electrode fingers by the analyte liquid. The protective film 28 may cover the individual electrode fingers without being exposed, so as to avoid electrical short-circuiting between them, and hence, for example, each electrode finger and the protective film 28, as well as the upper surface 10a of the element substrate 10 and the protective film 28, may be spaced apart to a limited extent that would not interfere with propagation of SAW generated or received by the IDT electrode.

The protective film 28 may be made smaller in thickness than the first IDT electrode 11 and the second IDT electrode 12. This makes it possible to reduce the influence of the protective film 28 upon SAW propagating between the first IDT electrode 11 and the second IDT electrode 12, and thereby reduce losses of SAW energy. In this case, the protective film 28 may be configured so that at least part of an upper surface thereof is positioned at a level lower than the upper surface of the first IDT electrode 11 and the upper surface of the second IDT electrode 12.

Moreover, in the present embodiment, the protective film 28 may be made to have a compressive stress. For example, the compressive stress is measured using a warp gauge or in accordance with Raman spectrometry. When using the warp gauge, the compressive stress of the protective film 28 is measured on the basis of the amount of warpage of each of the protective film 28-bearing element substrate 10 and the protective film 28-free element substrate 10 (the element substrate 10 with the protective film 28 removed). When adopting the Raman spectrometry, the compressive stress of the protective film 28 is measured on the basis of Raman spectra in each of the protective film 28-bearing part of the element substrate 10 and the protective film 28-free part (the part with the protective film 28 removed) of the element substrate 10. For example, by adjusting the protective film 28 to be greater than or equal to 50 Mpa in compressive stress, it is possible to reduce losses due to the placement of a liquid (for example, analyte liquid) on the reaction portion, and thereby achieve measurement with greater accuracy. Alternatively, the compressive stress of the protective film 28 may be measured using an X-ray on the basis of the lattice conditions of the protective film 28 in itself.

(Reaction Portion 13)

The reaction portion 13 is disposed in the region between the first IDT electrode 11 and the second IDT electrode 12. In the present embodiment, as described above, the protective film 28 covers the first IDT electrode 11 and the second IDT electrode 12, and, as shown in FIG. 7, the reaction portion 13 is disposed on the upper surface of the protective film 28 so as to lie between the first IDT electrode 11 and the second IDT electrode 12, as seen in plan view.

In the present embodiment, the reaction portion 13 comprises: the immobilization film 13a (for example, a metallic film) located on the upper surface 10a of the element substrate 10; and a reactant bound to the upper surface of the immobilization film 13a, the reactant reacting with a detection target. For example, the immobilization film 13a and the reactant may be either chemically bound together or bound together via an intermediary substance, or, they may be brought into physical adhering contact with each other. The selection of the reactant is suitably made in accordance with the detection target. For example, when a specific cell or living tissue in an analyte liquid is detected as a detection target, a nucleic acid- or peptide-made aptamer may be used as the reactant, or, when a specific antigen in an analyte liquid is detected as a detection target, an antibody can be used. In the present embodiment, as a reaction between the reactant and the detection target, for example, the reactant and the detection target are bound together under a chemical reaction or an antigen-antibody reaction. Alternatively, the detection target may be adsorbed on the reactant under detection target-reactant interaction. The reaction is not limited thereto, and hence, as the reactant of the present embodiment for use in the reaction portion 13, it is possible to use a reactant which causes, by its presence, variation in SAW characteristics upon contact of the detection target with the reaction portion 13, depending on the type or content of the detection target. The reaction portion 13 serves to react with a detection target contained in an analyte liquid, and more specifically, upon contact of the analyte liquid with the reaction portion 13, a specific detection target contained in the analyte liquid is bound to an aptamer adapted to a reaction with the detection target.

In the present embodiment, the reaction portion 13 is situated on the upper surface 10a of the element substrate 10 via the protective film 28, so as to lie between the first IDT electrode 11 and the second IDT electrode 12. That is, the immobilization film 13a is spaced away from the upper surface 10a of the element substrate 10 by a distance corresponding to the thickness of the protective film 28. Since the reaction portion 13 is not covered with the protective film 28, the reaction portion 13 can contact with the analyte liquid.

The immobilization film 13a may be either of a single-layer structure composed of, for example, a gold layer, or of a multilayer structure such as a two-layer structure composed of a titanium layer and a gold layer lying on the titanium layer or a two-layer structure composed of a chromium layer and a gold layer lying on the chromium layer. Moreover, the immobilization film 13a may be formed of the same material as that used for the first IDT electrode 11 and the second IDT electrode 12. In this case, the immobilization film 13a and the first and second IDT electrodes 11 and 12 can be formed in one process step. Instead of the above-mentioned metallic film, for example, an oxide film such as a SiO₂ film or TiO₂ film may be used as the material for forming the immobilization film 13a.

In the example shown in FIG. 5, the metallic film 13R provided in the reference section 30R serves to output a reference signal with respect to a signal obtained by the detection section 30. For contradistinction to the detection section 30, the metallic film 13R is made identical in configuration to the immobilization film 13a, viz., the reaction portion 13 devoid of the reactant. Like the reaction portion 13, the metallic film 13R is also located on the upper surface 10a of the element substrate 10 via the protective film 28, so as to lie between the first IDT electrode 11 and the second IDT electrode 12. That is, the metallic film 13R is spaced away from the upper surface 10a of the element substrate 10 by a distance corresponding to the thickness of the protective film 28. Since the metallic film 13R is not covered with the protective film 28, the metallic film 13R can contact with the analyte liquid.

(Extraction Electrodes 19 and 20)

As shown in FIG. 5, the first extraction electrode 19 is connected to the first IDT electrode 11, and the second extraction electrode 20 is connected to the second IDT electrode 12. The first extraction electrode 19 is extracted from the first IDT electrode 11 in the opposite direction to the reaction portion 13, and, an end 19e of the first extraction electrode 19 is electrically connected to the wiring line 7 disposed on the first cover member 1. The second extraction electrode 20 is extracted from the second IDT electrode 12 in the opposite direction to the reaction portion 13, and, an end 20e of the second extraction electrode 20 is electrically connected to the wiring line 7.

The first extraction electrode 19 and the second extraction electrode 20 may be formed of the similar material to that used for the first IDT electrode 11 and the second IDT electrode 12 and may have the similar structure to the first IDT electrode 11 and the second IDT electrode 12, and hence, for example, the first and second extraction electrodes may be either of a single-layer structure composed of, for example, a gold thin layer, or of a multilayer structure such as a three-layer structure obtained by successively laminating a titanium layer, a gold layer, and a titanium layer in the order named, or a chromium layer, a gold layer, and a chromium layer in the order named, from the element substrate 10 side.

In the present embodiment, the quartz-made element substrate 10 has the following Euler angles, φ=0°, 97.2°≤θ≤128.9°, and 85°≤ψ≤95°, and, an expression 0<tc≤0.17λ is satisfied, in which tc denotes a thickness of a part of the protective film 28 covering the first IDT electrode 11 and the second IDT electrode 12. The fulfillment of such a prescribed range of Euler angles in the element substrate 10 and the thickness of the protective film 28 allows improvement in temperature characteristics.

In the present embodiment, the temperature characteristics of the sensor element can be determined as TCF (Temperature Coefficients of Frequency) by leaving the sensor element to stand in a thermostatic chamber under different internal temperature conditions, namely 10° C., 25° C., and 40° C., respectively, measuring the frequency response characteristics of the sensor element under each temperature condition, and calculating a frequency change per unit temperature variation. It can be judged that the sensor element exhibits increasingly higher level of temperature characteristics as the TCF is decreased. That is, the lower the TCF is, the higher the level of temperature characteristics is, which means that a decline in measurement accuracy resulting from a change in temperature can be reduced. In a conventional sensor element, for example, temperature characteristics TCF thereof is about 75 ppm/° C. or greater in terms of absolute value (TCF≤−75 ppm, and, 75 ppm TCF). When incorporated in medical equipment required to afford high measurement accuracy, this sensor element may suffer a decline in measurement accuracy under the influence of temperature changes. In this regard, the sensor element 3 in the present embodiment fulfills the above-described range of Euler angles in the element substrate 10 and the thickness of the protective film 28, and hence achieves improvement in temperature characteristics up to a level where TCF falls within a range of ±5 ppm/° C. (TCF satisfies −5 ppm≤TCF≤5 ppm). With the improvement of the temperature characteristics, for example, even if the sensor device 100 is placed in service under various environmental conditions, such as outdoors and indoors, measurement can be accomplished with high accuracy regardless of temperatures. In the present embodiment, for example, the attainment of high measurement accuracy is ascertained with use of the coefficient of variation (CV) of a measured value obtained by detection of a detection target by the sensor element with consideration given only to the influence of temperature changes. In the present embodiment, the range of the temperature characteristics TCF is not limited to ±5 ppm/° C., and hence TCF may take on any values that would achieve greater measurement accuracy than has hitherto been obtainable. For example, the temperature characteristics TCF may be adjusted to fall within a range of ±15 ppm/° C.

(Detection of Detection Target by Sensor Element 3)

In the process of detecting a detection target contained in an analyte liquid by the sensor element 3 which utilizes SAW thus far described, a signal from the signal generator SG is first inputted to the first IDT electrode 11 via the wiring line 7, the first extraction electrode 19, etc.

Upon inputting the signal, in the detection section 30, a region of the surface of the element substrate 10 in which the first IDT electrode 11 is formed is excited, thus producing SAW having a predetermined frequency. Part of the SAW generated propagates toward the reaction portion 13, passes through the reaction portion 13, and reaches the second IDT electrode 12. In the reaction portion 13, an aptamer at the reaction portion 13 is bound to a specific detection target contained in the analyte liquid, and the weight (mass) of the reaction portion 13 changes by an amount corresponding to the binding, with consequent variation in the characteristics, such as the phase, of the SAW passing through the reaction portion 13. In response to the arrival of the SAW having varied characteristics at the second IDT electrode 12, a corresponding detection voltage is developed in the second IDT electrode 12. In the case of providing the reference section 30R, in a like manner, following the propagation and passage of SAW through metallic film 13R, a reference voltage is developed.

The thus developed voltage is outputted, through the second extraction electrode 20, the wiring line 70, etc., to the calculation section 140 and the measurement section 150 to examine properties and constituents of the analyte liquid.

In the sensor device main body 101, capillarity is utilized to direct the analyte liquid to the reaction portion 13.

More specifically, as described above, upon joining the second cover member 2 to the intermediate cover member 1A, as shown in FIG. 2, the flow channel 15 is defined, in the form of a narrow elongate pipe, on the lower surface of the second cover member 2. Thus, by setting the dimensions such as the width and the diameter of the flow channel 15 at predetermined values with consideration given to the type of the analyte liquid, the materials for forming the intermediate cover member 1A and the second cover member 2, etc., it is possible to cause capillarity in the flow channel 15 in the form of a narrow elongate pipe. For example, the flow channel 15 has a width of 0.5 mm to 3 mm, and a depth of 0.1 mm to 0.5 mm. As shown in FIG. 2(b), the flow channel 15 has a downstream portion (extended portion) 15b which is a portion extending beyond the reaction portion 13, and, the second cover member 2 is formed with the exhaust hole 18 which is continuous with the extended portion 15b. Upon entering the analyte liquid into the flow channel 15, air present inside the flow channel 15 is expelled out of the exhaust hole 18.

With such a pipe-like channel capable of causing capillarity defined by the cover members including the intermediate cover member 1A and the second cover member 2, upon contact of the analyte liquid with the inlet 14, the analyte liquid is drawn into the interior of the sensor device main body 101 while passing through the flow channel 15. Thus, the sensor device main body 101 is capable of directing the analyte liquid to the reaction portion 13 by means of an analyte liquid suction mechanism of its own without the necessity of using an instrument such as a pipette.

(Positional Relationship Between Flow Channel 15 and Sensor Element 3)

In the present embodiment, the flow channel 15 for analyte liquid has a depth of about 0.3 mm, whereas the sensor element 3 has a thickness of about 0.3 mm, that is; as shown in FIG. 2(b), the depth of the flow channel 15 and the thickness of the sensor element 3 are substantially equal. Therefore, if the sensor element 3 is placed as it is on the upper surface of the first cover member 1, the flow channel 15 will be blocked. In this regard, in the sensor device main body 101, as shown in FIG. 2(b), the element receiving portion 5 is defined by the first cover member 1 on which the sensor element 3 is mounted, and the intermediate cover member 1A joined onto the first cover member 1. The sensor element 3 is received in this element receiving portion 5 to avoid a blockage in the flow channel 15 for analyte liquid. That is, the depth of the element receiving portion 5 is adjusted to be substantially equal to the thickness of the sensor element 3, and the sensor element 3 is mounted inside the element receiving portion 5, thus ensuring the flow channel 15.

The sensor element 3 is secured to the bottom surface of the element receiving portion 5 by a die-bonding material composed predominantly of resin such as epoxy resin, polyimide resin, or silicone resin, for example.

The end 19e of the first extraction electrode 19 and the wiring line 7 are electrically connected to each other by a metallic narrow wire 27 formed of Au, for example. The connection between the end 20e of the second extraction electrode 20 and the wiring line 7 is made in a similar manner. Means for connecting each of the first extraction electrode 19 and the second extraction electrode 20 to the wiring line 7 is not limited to the metallic narrow wire 27, but may be an electrically-conductive adhesive such as a Ag paste, for example. With a clearance left in the part of connection between the wiring line 7 and each of the first extraction electrode 19 and the second extraction electrode 20, damage of the metallic narrow wire 27 can be suppressed when bonding the second cover member 2 to the first cover member 1. Moreover, the first extraction electrode 19, the second extraction electrode 20, the metallic narrow wire 27 and the wiring line 7 may be covered with the protective film 28. Since the first extraction electrode 19, the second extraction electrode 20, the metallic narrow wire 27 and the wiring line 7 are covered with the protective film 28, it is possible to suppress corrosion of these electrodes or the like.

As described heretofore, in accordance with the sensor device main body 101 according to the present embodiment, by placing the sensor element 3 in the element receiving portion 5 of the first cover member 1, it is possible to provide the flow channel 15 for analyte liquid extending from the inlet 14 to the reaction portion 13, and thereby allow the analyte liquid sucked from the inlet 14 under capillarity or by other means to flow to the reaction portion 13. That is, there is provided the sensor device main body 101 in which, even with use of the sensor element 3 having a certain thickness, an analyte liquid can be efficiently directed to the sensor element 3 by virtue of the analyte liquid suction mechanism of the device's own.

### Second Embodiment

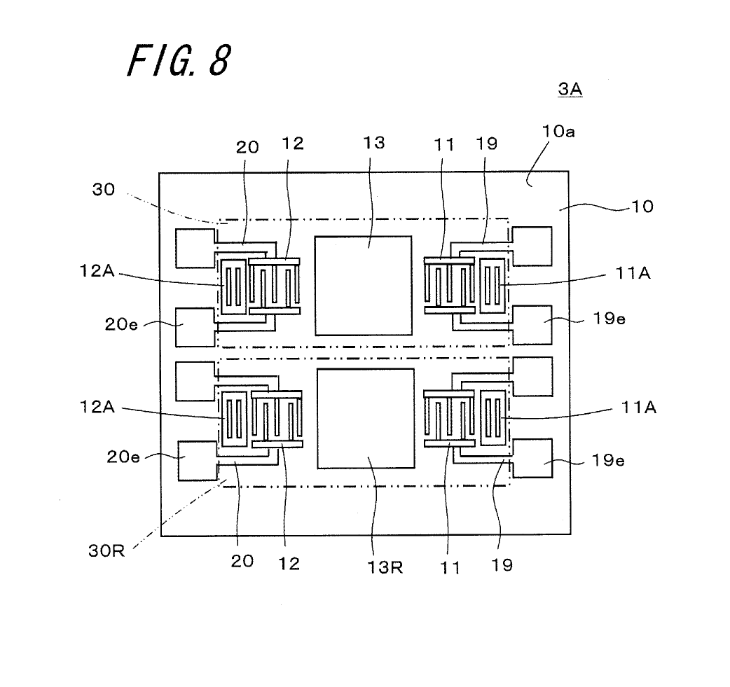

FIG. 8 is a plan view showing a sensor element according to a second embodiment.

A sensor element 3A according to the second embodiment of the invention comprises, in addition to the constituent components of the above-described sensor element 3 according to the first embodiment, a first reflector and a second reflector, and the protective film 28 covers the first reflector and the second reflector. For example, a thickness tr of a part of the protective film 28 covering the first reflector and the second reflector satisfies 0<tr≤0.05λ.

(First Reflector 11A and Second Reflector 12A)

In the present embodiment, the detection section 30 further includes the first reflector 11A and the second reflector 12A. The first reflector 11A is a reflector located opposite to the reaction portion 13 with respect to the first IDT electrode 11, and, the second reflector 12A is a reflector located opposite to the reaction portion 13 with respect to the second IDT electrode 12. Like the detection section 30, the reference section 30R may also include the first reflector 11A and the second reflector 12A.

Among the SAW propagating over the element substrate 10, SAW propagating outward from the first IDT electrode 11 and the second IDT electrode 12 is not used for measurement, with consequent energy losses. With the first reflector 11A and the second reflector 12A, SAW propagating outward from the first IDT electrode 11 and the second IDT electrode 12 can be reflected by the first reflector 11A and the second reflector 12A so as to be used for measurement. This makes it possible to reduce energy losses, and thereby attain higher noise immunity and hence higher measurement accuracy.

Moreover, in the present embodiment, like the first IDT electrode 11 and the second IDT electrode 12, the first reflector 11A and the second reflector 12A are covered with the protective film 28, and, the thickness tr of a part of the protective film 28 covering the first reflector 11A and the second reflector 12A satisfies 0<tr≤0.05λ. By covering the first reflector 11A and the second reflector 12A with the protective film 28, it is possible to suppress contact of an analyte liquid with the first reflector 11A and the second reflector 12A, and thereby reduce corrosion of the reflectors caused by oxidation, for example.

### Third Embodiment

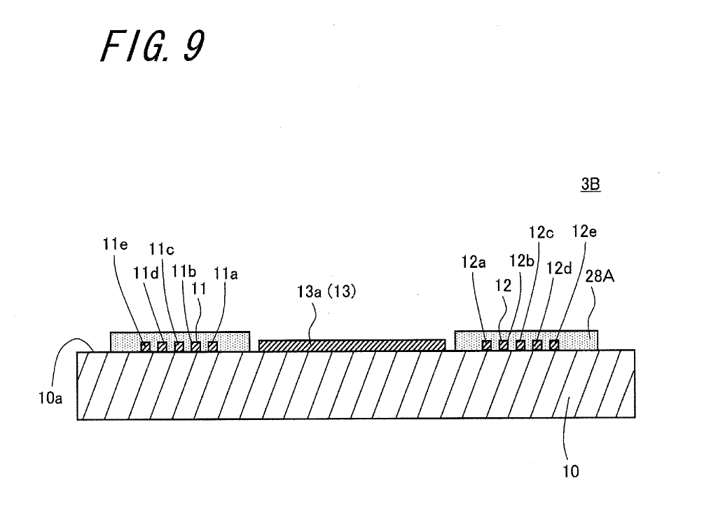

FIG. 9 is a sectional view showing a sensor element as a third embodiment.

A sensor element 3B according to the third embodiment of the invention differs from the foregoing embodiment in an area covered with a protective film 28A.

In the present embodiment, as shown in FIG. 9, a protective film 28A covers the first IDT electrode 11 and the second IDT electrode 12, but does not cover part of the region between the first IDT electrode 11 and the second IDT electrode 12. That is, part of the upper surface 10a of the element substrate 10 is not covered with the protective film 28A. The reaction portion 13 is located on a part of the upper surface 10a of the element substrate 10 which part is not covered with the protective film 28A, or equivalently a part of the upper surface 10a of the element substrate 10 which part lies between the first IDT electrode 11 and the second IDT electrode 12. The protective film 28A may cover the individual electrode fingers without being exposed, so as to avoid electrical short-circuiting between them, and hence, for example, each electrode finger and the protective film 28A, as well as the upper surface 10a of the element substrate 10 and the protective film 28A, may be spaced apart to a limited extent that would not interfere with propagation of SAW generated or received by the IDT electrode.

The SAW generated in the first IDT electrode 11, while propagating through the protective film 28A-bearing part of the upper surface 10a of the element substrate 10 under the influence of the protective film 28A, propagates through the protective film 28A-free part thereof without incurring the influence of the protective film 28A. In the present embodiment, the reaction portion 13 is placed so as to directly contact with the upper surface 10a of the element substrate 10, wherefore SAW is allowed to propagate while acting more effectively on the reaction portion 13 lying on the upper surface 10a of the element substrate 10. This makes it possible to achieve further reduction in energy losses, and thereby attain higher noise immunity and hence higher measurement accuracy.

Moreover, the center-side end of the protective film 28A and the IDT electrode-side end of the reaction portion 13 may either contact with each other or be spaced apart without contact. By contacting the ends with each other, it is possible to reduce acoustical boundaries in the SAW propagation path, and thereby achieve efficient transmission of vibration energy generated in the IDT electrode 11 to the reaction portion 13, with consequent loss reduction. On the other hand, by spacing the ends apart without contact, it is possible to maintain the exposed length of the reaction portion 13 invariant even if the end of the protective film 28A is displaced from its normal position due to manufacturing variation, and thereby reduce variation in sensitivity.

<Sensor Element Manufacturing Process>

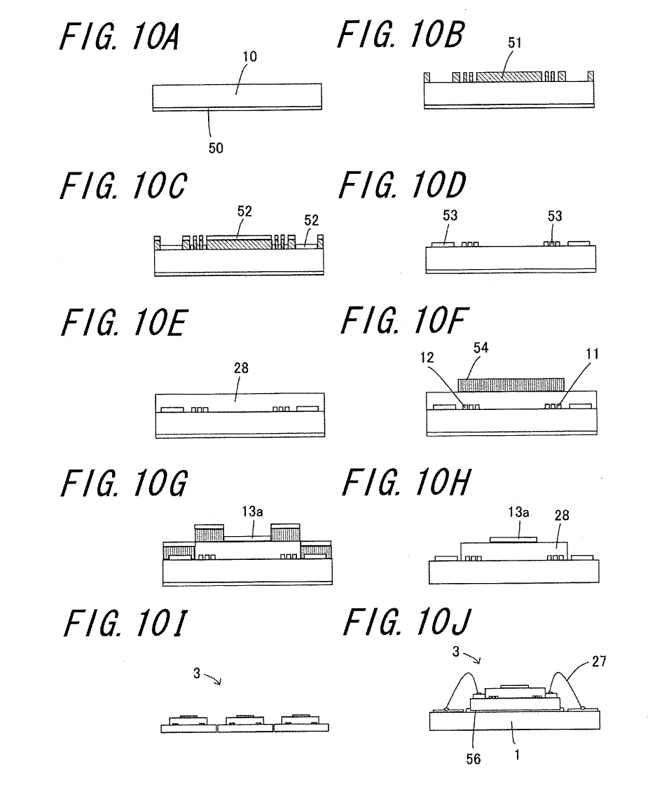

The following describes a procedure in the manufacturing of the sensor element 3 provided in the sensor device main body 101 according to the embodiment of the invention. FIG. 10 is a schematic view showing procedural steps for the manufacturing of the sensor element 3.

First, a quartz-made element substrate 10 is washed. After that, on an as needed basis, an Al film 50 is formed on the lower surface of the element substrate 10 by RF sputtering (FIG. 10(a)).

Next, an electrode pattern is formed on the upper surface 10a of the element substrate 10. In this process, a photoresist pattern 51 of image reversal type for electrode pattern formation is formed by photolithography technique (FIG. 10(b)).

Next, a metallic layer 52 having a three-layer (Ti/Au/Ti) structure is formed on each of a photoresist pattern 51-bearing part and a photoresist pattern 51-free part of the upper surface 10a of the element substrate 10 by an electron beam evaporation apparatus (FIG. 10(c)).

Next, a Ti/Au/Ti electrode pattern 53 is formed by lifting off the photoresist pattern 51 with use of a solvent, and thereafter performing oxygen-plasma ashing treatment (FIG. 10(d)). In the present embodiment, the Ti/Au/Ti electrode pattern 53 may define, in addition to a pair of IDT electrodes 11 and 12, reflectors, extraction electrodes 19 and 20 for mounting purposes, etc. The pair of IDT electrodes 11 and 12 are arranged so as to face each other, and, one of them serves as a transmitter, whereas the other serves as a receiver.

Next, the protective film 28 is formed on the upper surface 10a of the element substrate 10 so as to cover the Ti/Au/Ti electrode pattern 53 by TEOS (Tetra Ethyl Ortho Silicate)-plasma CVD technique, for example (FIG. 10(e)).

Next, a pattern of the protective film 28 is formed by forming a positive photoresist 54 on the upper surface of the protective film 28, and thereafter etching the protective film 28 by RIE equipment (FIG. 10(f)). More specifically, the protective film 28 pattern for covering the IDT electrodes 11 and 12 and also the region between the IDT electrodes 11 and 12 is formed by forming the positive photoresist 54 on a part of the protective film 28 covering the IDT electrodes 11 and 12 and the region between them, etching a photoresist 54-free part of the protective film 28 by RIE equipment, and lifting off the photoresist 54 with use of a solvent.

The immobilization film 13a is formed on the upper surface of the protective film 28. Herein, a photoresist pattern 54 of image reversal type for the formation of the immobilization film 13a is formed by photolithography technique, and then a metallic layer having a three-layer (Ti/Au/Ti) structure is formed on each of a photoresist pattern 54-bearing part and a photoresist pattern 54-free part of the upper surface 10a of the protective film 28 by an electron beam evaporation apparatus (FIG. 10(g)).

Next, a Ti/Au/Ti immobilization film 13a is formed by lifting off the photoresist pattern 54 with use of a solvent, and thereafter performing oxygen-plasma ashing treatment (FIG. 10(h)).

After that, the Al film 50 formed on the lower surface of the element substrate 10 is removed with use of fluoronitric acid. A nucleic acid- or peptide-made aptamer is immobilized on the upper surface of the immobilization film 13a to form the reaction portion 13.

The sensor element 3 is formed in the manner thus far described.

Next, the element substrate 10 is divided into pieces of predetermined size by dicing (FIG. 10(i)). After that, separate sensor elements 3 obtained by the dividing process are fixedly attached, at their back sides, onto a wiring-bearing glass epoxy mounting substrate (hereafter referred to as “mounting substrate”) corresponding to the first cover member 1 with use of an epoxy adhesive 56. Then, a Au narrow wire is used as the metallic narrow wire 27, and provides electrical connection between the end 19e, 20e of the extraction electrode disposed on the sensor element 3 and the wiring line 7 connected to the terminal 6 disposed on the mounting substrate (FIG. 10(j)).

With subsequent installation of the intermediate cover member 1A, the second cover member 2, etc. being accomplished, the sensor device main body 101 according to the embodiment of the invention is formed.

Meanwhile, a substrate installed with each of the signal generator SG, the calculation section 140, and the measurement section 150 constructed of, for example, a semiconductor element is prepared independently of the sensor device main body 101, and, with subsequent electrical connection between the sensor device main body 101 thus obtained and each semiconductor element being established, the sensor device 100 is formed.

The invention may be carried into effect in various forms without being limited to the embodiments thus far described. For example, although the reaction portion 13 in the above-described embodiments has been illustrated as comprising the immobilization film 13a and the aptamer immobilized on the upper surface of the immobilization film 13a, a substance to be immobilized on the upper surface of the immobilization film 13a is not limited to the aptamer, but may be any of reactants that react with a detection target contained in an analyte liquid with consequent changes in SAW characteristics before and after the passage of the sample through the reaction portion 13. Moreover, for example, where the immobilization film 13a is capable of reaction with the detection target in the analyte liquid, the reaction portion 13 may be composed solely of the immobilization film 13a without using a reactant such as the aptamer. In addition, as the immobilization film 13a, instead of the metallic film, it is possible to use a non-conductive film, on the upper surface of which is immobilized an aptamer.

Moreover, the sensor element 3 may be constructed by co-arranging a plurality of different elements on a single substrate. For example, an enzyme electrode for use with an enzyme electrode method may be disposed next to a SAW element. In this case, in addition to measurement based on an immunization method using an antibody or aptamer, enzymatic method-based measurement can also be conducted, wherefore increasing numbers of measurement points can be checked at one time.

Moreover, although the foregoing embodiments have been described with respect to the case where there is provided a single sensor element 3, a plurality of the sensor elements 3 may be arranged. In this case, the element receiving portion 5 may be provided for each sensor element 3 on an individual basis, or, the element receiving portion 5 may be configured to have a length or width large enough to receive all the sensor elements 3.

Moreover, although the foregoing embodiments have been described with respect to the case where the first cover member 1, the intermediate cover member 1A, and the second cover member 2 are provided as separate components, this is not intended to be limiting of the invention, and hence either a combination of some of these members in an unitary structure or a combination of all the members in an unitary structure may be adopted.

Moreover, the described constituent components of the embodiments may be used in combination. For example, the first reflector and the second reflector of the sensor element 3A as the second embodiment may be applied to the sensor element 3B as the third embodiment.

### EXAMPLES

(Study in Simulation)

With use of the values of Euler angles (φ, θ, ψ) of the quartz substrate serving as the element substrate 10 and the thickness tc of a part of the protective film 28 covering the first IDT electrode 11 and the second IDT electrode 12 as parameters, the above-described temperature coefficients of frequency (TCF) were calculated by simulation. In this simulation, TCF was determined by calculation using software employing a finite-element method (FEM) (MATLAB manufactured by The MathWorks, Inc.).

In the simulation, Euler angles φ, θ, and ψ were set to satisfy φ=0°, 0°≤θ≤180°, and 0°≤ψ≤90°, and a protective film thickness tc was adjusted to satisfy the expression 0≤tc≤0.2λ. TCF corresponding to each condition was calculated, and then a mathematical expression representing the relationship between TCF [ppm/° C.], tc [μm] and θ [°] was derived. The derived relational expression is as follows:

TCF=−11.1θtc+3.1θ+1615.1tc−390 (where φ=0°, and ψ=90°) (1).

The range of Euler angles and the range of protective film thickness tc with which TCF falls within a ±5 ppm/° C. range were determined in accordance with the expression (1).

It has been found that TCF fell within a range of ±5 ppm/° C. when the Euler angles of the element substrate had φ=0°, 97.2°≤θ≤128.9°, and 85°≤ψ≤95°, and the thickness of the protective film satisfied 0<tc≤0.17λ.

(Verification with Measured Values)

The adequacy of the range of Euler angles and the range of protective film thickness obtained by the described study in simulation was verified on the basis of measured values.

Example of Verification 1

TCF (Temperature Coefficients of Frequency) measurement was made on a sensor element produced in conformity with the design of the above-described embodiment in a manner whereby the Euler angles of the element substrate were such that φ, θ, and ψ were equal to 0°, 128°, and 90°, respectively, and the protective film thickness tc was equal to 0.026λ. The result showed that TCF stood at 4.9 ppm/° C., from which it followed that TCF could fall within a range of ±5 ppm/° C. when the Euler angles and the protective film thickness fulfilled their respective ranges set in the simulation.

Example of Verification 2

TCF measurement was made on a sensor element produced in conformity with the design of the above-described embodiment in a manner whereby the Euler angles of the element substrate were such that φ, θ, and ψ were equal to 0°, 127°, and 90°, respectively, and the protective film thickness tc was equal to 0.026λ. The result showed that TCF stood at 0.9 ppm/° C., from which it followed that TCF could fall within a range of ±5 ppm/° C. when the Euler angles and the protective film thickness fulfilled their respective ranges set in the simulation.

Example of Verification 3

TCF measurement was made on a sensor element produced in conformity with the design of the above-described embodiment in a manner whereby the Euler angles of the element substrate were such that φ, θ, and ψ were equal to 0°, 126°, and 90°, respectively, and the protective film thickness tc was equal to 0.026λ. The result showed that TCF stood at −4.8 ppm/° C., from which it followed that TCF could fall within a range of ±5 ppm/° C. when the Euler angles and the protective film thickness fulfilled their respective ranges set in the simulation.

Example of Verification 4

TCF measurement was made on a sensor element produced in conformity with the design of the above-described embodiment in a manner whereby the Euler angles of the element substrate were such that φ, θ, and ψ were equal to 0°, 127°, and 90°, respectively, and the protective film thickness tc was equal to 0.026λ. The result showed that TCF stood at −2.5 ppm/° C., from which it followed that TCF could fall within a range of ±5 ppm/° C. when the Euler angles and the protective film thickness fulfilled their respective ranges set in the simulation.

Example of Verification 5

TCF measurement was made on a sensor element produced similarly to those produced for the above-described verification examples in a manner whereby the Euler angles of the element substrate were such that φ, θ, and ψ were equal to 0°, 132.9°, and 90°, respectively, and the protective film thickness tc was equal to 0.026λ. The result showed that TCF stood at 31.9 ppm/° C., from which it followed that TCF could not fall within a range of ±5 ppm/° C. when the Euler angles and the protective film thickness fell outside their respective ranges set in the simulation.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### REFERENCE SIGNS LIST

1: First cover member
1A: Intermediate cover member
1Aa: First upstream portion
2: Second cover member
2a: Third substrate
2b: Fourth substrate
3, 3A, 3B: Sensor element
4: Recess-forming area
5: Element receiving portion
6: Terminal
7: Wiring line
10: Element substrate
11: First IDT electrode
11A: First reflector
11a: Electrode finger
12: Second IDT electrode
12A: Second reflector
12a: Electrode finger
13: Reaction portion
13R: Metallic film
13a: Immobilization film
14: Inlet
15: Flow channel
15b: Downstream portion
18: Exhaust hole
19: First extraction electrode
19e: End
20: Second extraction electrode
20e: End
27: Metallic narrow wire
28, 28A: Protective film
30: Detection section
30R: Reference section
50: Al film
51: Photoresist pattern
52: Metallic layer
53: Electrode pattern
54: Photoresist
56: Epoxy adhesive
100: Sensor device
101: Sensor device main body
140: Calculation section
150: Measurement section

1. A sensor element for detecting a detection target contained in a sample, comprising:
a quartz substrate having the following Euler angles, φ=0°, 97.2°≤θ≤128.9°, and 85°≤ψ≤95°;
a detection section located on an upper surface of the quartz substrate, the detection section comprising
a reaction portion which reacts with the detection target,
a first IDT electrode which generates a surface acoustic wave which propagates toward the reaction portion, and
a second IDT electrode which receives a surface acoustic wave which has passed through the reaction portion; and
a protective film covering at least the first IDT electrode and the second IDT electrode, an expression 0<tc≤0.17λ being satisfied, in which tc denotes a thickness of a part of the protective film covering the first IDT electrode and the second IDT electrode, namely denotes a thickness standardized by a wavelength λ (μm) of the surface acoustic wave.

2. The sensor element according to claim 1, wherein the protective film has a compressive stress.

3. The sensor element according to claim 1, wherein the protective film contains SiO₂.

4. The sensor element according to claim 1, wherein at least a part of the protective film is located on the upper surface of the quartz substrate.

5. The sensor element according to claim 1, wherein the protective film is configured to contact with the first IDT electrode and the second IDT electrode.

6. The sensor element according to claim 5, wherein
each of the first IDT electrode and the second IDT electrode has a plurality of electrode fingers, and
the protective film is configured to contact with surfaces of the plurality of electrode fingers of the first IDT electrode and the second IDT electrode, and also a surface of a part of the quartz substrate which lies between the plurality of electrode fingers.

7. The sensor element according to claim 1, wherein the protective film does not cover the reaction portion.

8. The sensor element according to claim 1, wherein the protective film continuously covers a region from the first IDT electrode to the second IDT electrode.

9. The sensor element according to claim 1, wherein the reaction portion is located on the upper surface of the quartz substrate via the protective film.

10. The sensor element according to claim 1, wherein the reaction portion comprises a reactant capable of reacting with the detection target, and an immobilization film capable of binding with the reactant.

11. The sensor element according to claim 10, wherein the reactant is bound, via the immobilization film, to the quartz substrate.

12. The sensor element according to claim 10, wherein an expression 0.007λ≤tf is satisfied, in which tf denotes a thickness of the immobilization film.

13. The sensor element according to claim 1, wherein an expression 0.35 mm≤tb≤0.55 mm is satisfied, in which tb denotes a thickness of the quartz substrate.

14. The sensor element according to claim 1, wherein
the detection section further comprises a first reflector located opposite to the reaction portion with respect to the first IDT electrode, and a second reflector located opposite to the reaction portion with respect to the second IDT electrode, and
the protective film further covers the first reflector and the second reflector, and, an expression 0<tr≤0.05λ is satisfied, in which tr denotes a thickness of a part of the protective film covering the first reflector and the second reflector.

15. The sensor element according to claim 14, wherein an expression 0<tc≤0.05λ is satisfied.

16. The sensor element according to claim 1, wherein the quartz substrate has the following Euler angles, φ=0°, 110.0°≤θ≤128.9°, and 85°≤ψ≤95°.

17. A sensor device, comprising:
a sensor element according to claim 1;
a supply section which delivers the sample containing the detection target to the detection section of the sensor element; and
a signal processing section which detects the detection target based on an electrical signal outputted from the sensor element.
